(19) United States
(12) Patent Application Publication
(10) Pub. No.: US 2010/0148954 A1
(43) Pub. Date: Jun. 17, 2010

(54) Mobile handset proximity location

(75) Inventor: Joseph A. Bobier, Sunrise, FL (US)

Correspondence Address: THE LAW OFFICES OF DENNIS L. COOK, PLLC, 10004 MARATHON COURT, TAMPA, FL, 33615, US

(73) Assignee: xG Technology, Inc., Sarasota, FL (US)

(21) Appl. No.: 12/653,444

(22) Filed: Dec. 14, 2009

Related U.S. Application Data
(60) Provisional application No. 61/201,808, filed on Dec. 15, 2008.

(51) Int. Cl. G08B 1/08

(52) U.S. Cl. 340/539.11; 340/539.32

(57) ABSTRACT

A system and method which allows for a more direct form of presenting useful information to a mobile handset user is disclosed. More specifically a method to supply increased functionality to a mobile handset by adding a friend location function to mobile handsets, and to provide a location/homing function to mobile handsets when they are within a prescribed relative range of each other.

### CROSS-REFERENCE TO RELATED APPLICATION

The present application claims the benefit of previously filed co-pending Provisional Patent Application, Ser. No. 61/201,808.

### FIELD OF INVENTION

This invention relates to a system which allows for a more direct form of presenting useful information to a mobile handset user, and more specifically is a method that adds a friend location function to mobile handsets.

### BACKGROUND OF INVENTION

Keeping track of family, friends, or employees is something that has become easier with the advent of mobile phones. One quick phone call is all it usually takes to find out where someone is located. Of course there are times when making that phone call can be difficult such as when one is driving or the other person is not available to answer the phone. Thus, there is still a need for a reliable method to easily determine the location of someone when actually speaking to that person is not an option. This disclosure describes one method of location, and, in particular, the user interface features that will enable such location services.

The following disclosure will describe a method of making a friend location function available to all mobile handset users.

### BRIEF SUMMARY OF THE INVENTION

An invention is disclosed that adds a new that adds a friend location function to mobile handsets.

It is therefore an object of the invention to supply increased functionality to a mobile handset by adding a friend location function to mobile handsets, and, as a further object of the invention, to provide a location/homing function to mobile handsets when they are within a prescribed relative range of each other.

### DESCRIPTION OF PREFERRED EMBODIMENT

For purposes of the preferred embodiment suppose a mobile user is within some distance of another compatible user, perhaps in the order of a mile or two. The application software running in the mobile device will notify the similarly equipped user of his relative presence by an audible, visual and/or vibration alert. In particular, a user can locate another user by selecting from a menu of known users, a particular user he or she wishes to locate. The “searching handset” will listen to the radio channel or channels known to be used in a particular channel scheme for periodic broadcasts from the handset to be located. If the “find me” function of the second handset is activated, it will periodically broadcast a beacon identifier message that the searching handset will listen for. Once the two handsets are within radio contact range, a notification message on the searching handset will alert the user that the second handset is “in the vicinity”. Optionally, an alert message can also notify the second user that his handset has been found. If the searching handset moves closer to the second handset, the signal will get stronger. A relative signal strength indicator, generally a bar graph, will indicate the relative closeness of the two handsets, giving the searching handset an indication of progress when moving relatively closer or farther away. Users may then directly text each other within the proximity area. Text messages may be privately sent or sent via a chat room type application. A quick option is also provided to phone the other user by selecting the user in the list then pressing “dial”.

There are three ways to detect the relative proximity of one user to another. The first method is to detect other users that are within direct radio contact of each other. In this embodiment each handset will periodically transmit an announcement beacon, which is not processed by the base station network.

The second method is by use of a GPS receiver within each handset to routinely note the present location. Signaling to other users then takes place through the base station network. In this embodiment the mobile device transmits its location information to the base station network on a periodic basis, then that announcement is re-broadcast to other local handsets and notification and registration will happen if the other users are within a prescribed relative proximity.

The third method makes use of other handset location methods such as triangulation, which is commonly done to locate handsets that are not equipped with GPS. It is essentially done the same way as method two, with somewhat less precision.

Since certain changes may be made in the above described mobile handset proximity social networking system and method without departing from the scope of the invention herein involved, it is intended that all matter contained in the description thereof, or shown in any accompanying figures shall be interpreted as illustrative and not in a limiting sense.

What is claimed is:

1. A method for proximity location between mobile phone or personal digital assistant users within a set proximity without using a base station comprising:
two or more users using a mobile phone or personal digital assistant having a location application software that stores information regarding friends and is capable of notifying a user of friends information;
said mobile phone or personal digital assistant transmitting beacons not processed by a base station with information regarding the identity of a user;
said mobile phone or personal digital assistant being capable of receiving said beacons when one user is within a set proximity of another user and showing the strength of said beacons; and,
wherein when said one user's said mobile phone or personal digital assistant receives said beacons of said another user's mobile phone or personal digital assistant within a set proximity said one user's mobile phone or personal digital assistant uses said location application software program to parse out the identity of said another user from said beacons and to notify said one user of the identity of said another user thus letting said one user know said another user is within a set proximity and said location application software program displays information regarding said another user to said one user through said mobile phone or personal digital assistant's display screen along with said signal strength indicator showing the closeness of said one user from said another user.

2. A method for proximity location between mobile phone or personal digital assistant users within a set proximity by using a base station comprising:
two or more users using a mobile phone or personal digital assistant having global positioning satellite location capability and a location application software that stores information regarding friends and is capable of notifying a user of friends information;
said mobile phone or personal digital assistant transmitting to a base station information regarding the identity of a user and location information;
said base station transmitting the identity and location information of a user to said mobile phone or personal digital assistant of two or more users within a set proximity;
said mobile phone or personal digital assistant being capable of using said location application software to recognize when one user is within a set proximity of another user; and,
wherein when said one user's said mobile phone or personal digital assistant recognizes that one user is within a set proximity of another user said one user's mobile phone or personal digital assistant uses said location application software program to notify said one user of the identity and location of said another user and said location application software program displays identity and location information regarding said another user to said one user through said mobile phone or personal digital assistant's display screen along with showing the closeness of said one user from said another user.

3. The method for proximity location between mobile phone or personal digital assistant users within a set proximity by using a base station of claim 2 wherein triangulation is used to determine location information.
